(19) United States
(12) Patent Application Publication
(10) Pub. No.: US 2003/0041271 A1
(43) Pub. Date: Feb. 27, 2003

(54) Reporting and handling multiple platform variants

(76) Inventors: Rajeev Nalawadi, Folsom, CA (US); Frederick Harr Bolay, Rancho Cordova, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/929,965

(22) Filed: Aug. 14, 2001

(51) Int. Cl. G06F 1/26

(52) U.S. Cl. 713/300

(57) ABSTRACT

Handling and processing of various capabilities of a plurality of platforms/systems. ACPI machine language (AML) code and device node structures are dynamically updated in a pre-OS execution environment after reading the General Purpose Inputs.

### BACKGROUND

The present invention relates to reporting and handling different capabilities of configuration and power management functionality.

Advanced Configuration and Power Interface (ACPI) is a power management tool that enables the operating system (OS) to adaptively control the amount of power used by each device attached to a computer. ACPI may command the operating system to go to sleep, to wake up, and to enable functionality at particular points in time. Therefore, the operating system may turn off peripheral devices, such as CD-ROM players and modems when the devices are not in use. Prior to the existence of ACPI, Advanced Power Management (APM) mechanism was used to handle the power management decisions. Most of the APM operating systems have switched to an ACPI mechanism. However, there are various operating systems that are still pre-ACPI.

Accordingly, ACPI may enable the operating system to manage power and/or resources by utilizing a pre-boot support code written in ACPI Machine Language (AML). Thus, dynamic updates occurring during pre-OS environment affect the Advanced Configuration and Power Management Interface (ACPI) Machine Language (AML) and the functionality of an ACPI Operating System (ACPI OS). The pre-boot code may include Basic Input/Output System (BIOS) or Extensible Firmware Interface (EFI) ROM image. EFI is supported as the firmware interface to boot the 64-bit version of Windows for the Intel Architecture. However, AML code does not determine the policies or time-outs for power or resource management. These policies are determined by the operating system. Accordingly, for each board/system with a particular capability, a new version of the pre-boot support code needs to be provided to handle control of the operating system.

### BRIEF DESCRIPTION OF THE DRAWINGS

FIG. 1 is a block diagram of Operating System directed configuration and Power Management (OSPM) system.

FIG. 2 is a detailed block diagram of an ACPI implementation according to an embodiment of the present invention.

FIG. 3 is a flowchart for the pre-boot support code that enables selection of ACPI capabilities according to specific board capabilities present in the platform hardware.

FIG. 4 is a block diagram of a processor-based system which may execute the pre-boot support code residing on the computer readable medium.

### DETAILED DESCRIPTION

In recognition of the above-stated difficulties with an existing Advanced Configuration and Power Management Interface (ACPI) design, the present invention describes embodiments for enabling a single ACPI-compliant pre-boot ROM image to handle capabilities of a plurality of boards/systems. However, the present embodiments may also handle pre-ACPI codes by updating device node structures. The flexibility afforded by the present invention is provided by the pre-boot support code, which dynamically updates ACPI machine language (AML) code before allowing the pre-operating-system (pre-OS) code, such as Basic Input Output System (BIOS), to pass control of the system to the operating system. Consequently for purposes of illustration and not for purposes of limitation, the exemplary embodiments of the invention are described in a manner consistent with such use, though clearly the invention is not so limited.

The present embodiments support a plurality of platforms/systems even in a pre-ACPI operating system by determining the platform variant using a set of General Purpose Input (GPI) values. In a pre-ACPI environment there are various device node structures that describe the platform capabilities to the operating system. The pre-OS environment may modify these device node structures being reported after reading the GPI values.

Accordingly, the present embodiments describe reporting and handling different capabilities of configuration and power management functionality by detecting variant features of a platform using General Purpose Input Output (GPIO) pins. There are various GPIO pins available in the chipset and the peripherals, which is sometimes referred to as Super I/O. The peripheral (e.g. Super I/O) and the chipset provide an ability to read a value on General Purpose Input (GPI) pins, and to write a particular value to General Purpose Output (GPO) pins. Furthermore, the peripheral and the chipset provide various other functionalities, such as providing a mechanism for software that has the capability to read and write the value of the GPIO pins. Thus, GPI pins may be strapped to a particular value to select a variant of the platform. For example, choosing a set of 4 GPI pins for determining the platform variant of a board/system enables the software to identify 16 different variants.

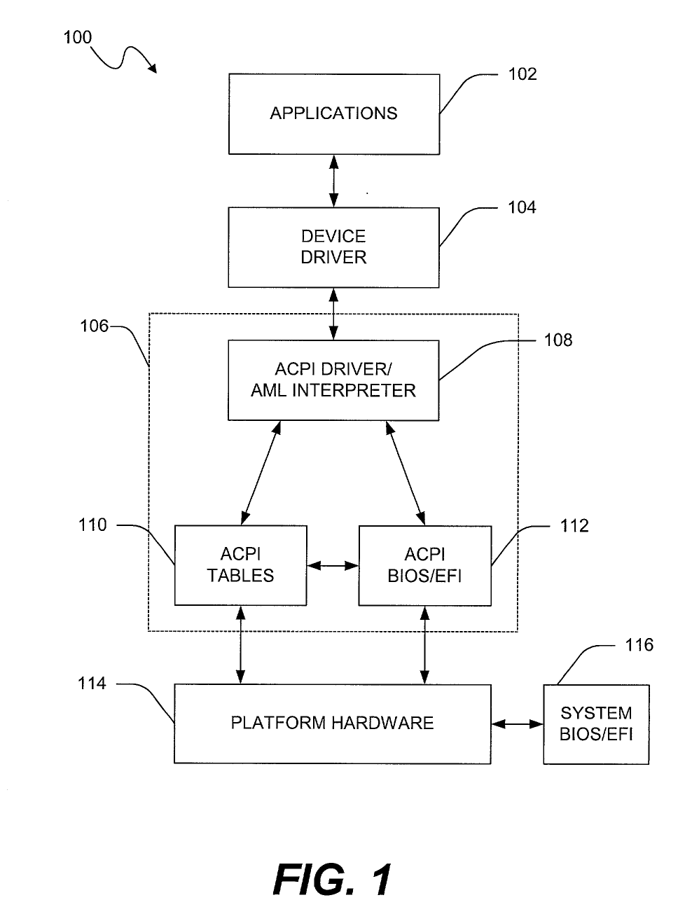

A block diagram of Operating System directed configuration and Power Management (OSPM) system 100 is shown in FIG. 1. The diagram defines the software and hardware components relevant to ACPI 106.

In OSPM system 100, the applications 102 may be implemented through device drivers 104 and ACPI drivers 108. Moreover, the role of an ACPI compliant BIOS/EFI 112 is to supply the ACPI tables 110 that describe the interfaces to the platform hardware 114. These interfaces may involve a variety of configurations and include the descriptions in AML code. The ACPI BIOS/EFI 112 may also include code that boots the machine, as well as implementing interfaces for various control operations. In some implementations, the ACPI BIOS/EFI 112 may be a part of the system BIOS/EFI 116.

Since the ACPI tables 110 may make use of AML that is interpreted, the operating system may include an AML interpreter 108 that executes procedures encoded in AML. Moreover, the procedures are accessed by parsing through the various ACPI tables 110. The AML code of the ACPI table 110 may include the Differentiated System Description Table (DSDT), which implements various ACPI control methods that are used during runtime functionality of the operating system. The ACPI control methods implement and configure various tasks related to power management, thermal management, or Plug-and-Play functionality. However, these tasks are not limited to the above-stated functions. Further, there are other ACPI tables that are part of the AML code reported to the Operating system. They include Root System Description Table (RSDT), Fixed ACPI Description Table (FADT), Firmware ACPI Control Structure (FACS), Secondary System Description Table (SSDT), Persistent System Description Table (PSDT), Multiple APIC Description Table (MADT), Embedded Controller Description Table (ECDT), Event Timer Description Table (ETDT), Smart Battery Specification Table (SBST), OEM specific table (OEMx), System Locality Information Table (SLIT), Serial Port Console Redirection Table (SPCR), Static Resource Affinity Table (SRAT), Simple Boot Flag Table (BOOT), Debug Port Table (DBGP), Server Platform management interface table (SPMI), and Extended System Description Table (XSDT). All these ACPI tables report various features and control for features that exist on the platform.

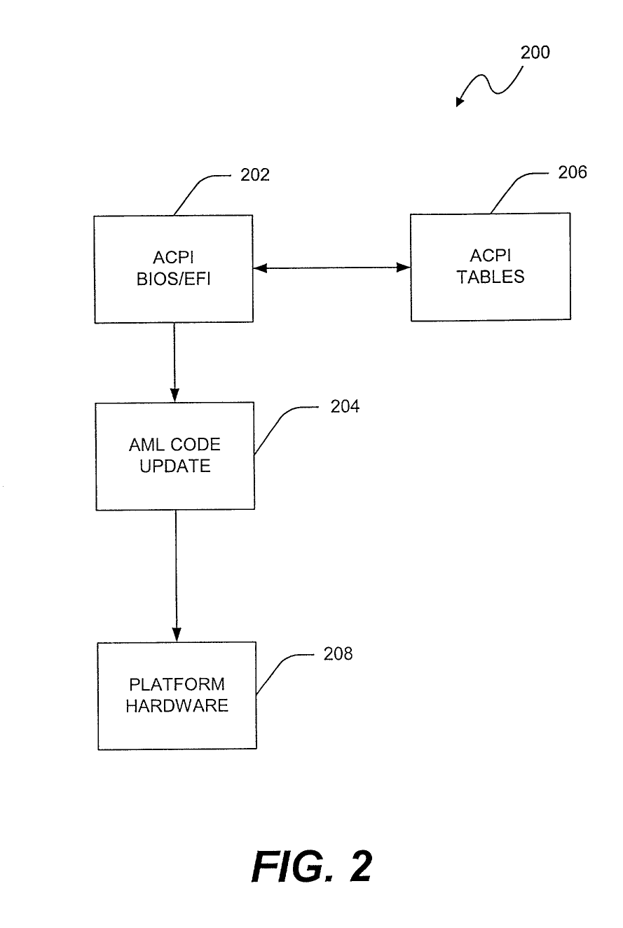

FIG. 2 illustrates a more detailed block diagram of an ACPI implementation 200 according to an embodiment of the present invention. In the illustrated embodiment, the ACPI tables 206 are described in terms of pointers to DSDT. However, other ACPI tables 206 described above may be used in place of, or in conjunction with, DSDT.

The ACPI implementation 200 shows an ACPI BIOS/EFI 202 which includes a pre-boot support code. This code enables selection of ACPI capabilities according to the board's stock keeping unit (SKU) that defines the capabilities of the board. The SKU may be presented in a form of a code or a physical identifier. The ACPI BIOS/EFI 202 searches for the pointer to the DSDT in the ACPI tables 206, which indicates the starting point of the AML code. The pre-boot support code in the ACPI BIOS/EFI 202 may then command the AML code update element 204 to update the AML code according to the board SKU. This allows the operating system to implement different ACPI capabilities on the platform hardware 208 using a single ROM image.

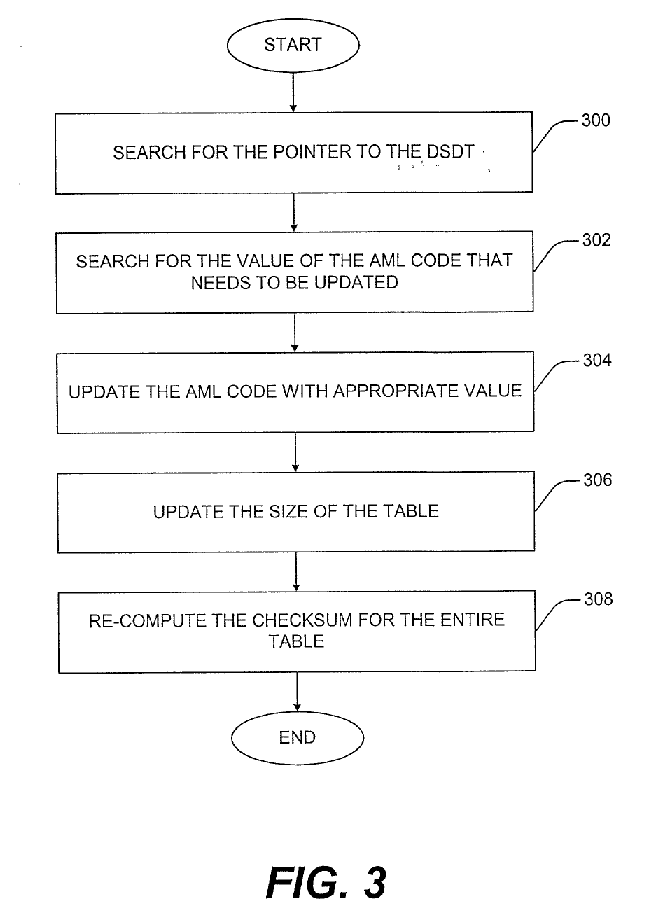

A flowchart for the pre-boot support code that enables selection of ACPI capabilities according to specific board capabilities present in the platform hardware is shown in FIG. 3. In the illustrated embodiment, the code implements a process for dynamically updating the AML code according to a specific board SKU. The process includes searching for a pointer to the Differentiated System Description Table (DSDT), at 300. The value of the AML code that needs to be updated is searched/provided at 302. At 304, the AML code is updated with an appropriate value corresponding to board capabilities. The size of the table may also be updated at 306. The checksum for the entire table may then be re-computed at 308.

One example implementation of the pre-boot support code of FIG. 3 is listed below in Table 1. The code shows a process for dynamically updating the AML code according to a specific board SKU. In particular, if one of the board SKUs supports suspend states S1, S3, S4, and S5, the ACPI source code reports this capability to the operating system by using the format of Name(_Sx, value to be written to SLP_TYP field), where x may be 1, 2, 3, 4, or 5 to represent suspend states S1 through 5, respectively. However, if another board SKU is capable of supporting only S1, S4, and S5, the Name(_S3, value) should not be reported to the operating system because the platform hardware does not support the suspend state S3. The example code updates the Name(_S3, xx) to Name(\SS3, xx) to disable S3 suspend capability reporting to the ACPI-capable operating system. Therefore, this support code allows for modifying the AML code dynamically before passing the control to the operating system so that the S3 capability is not visible or reported to the operating system for this board SKU.

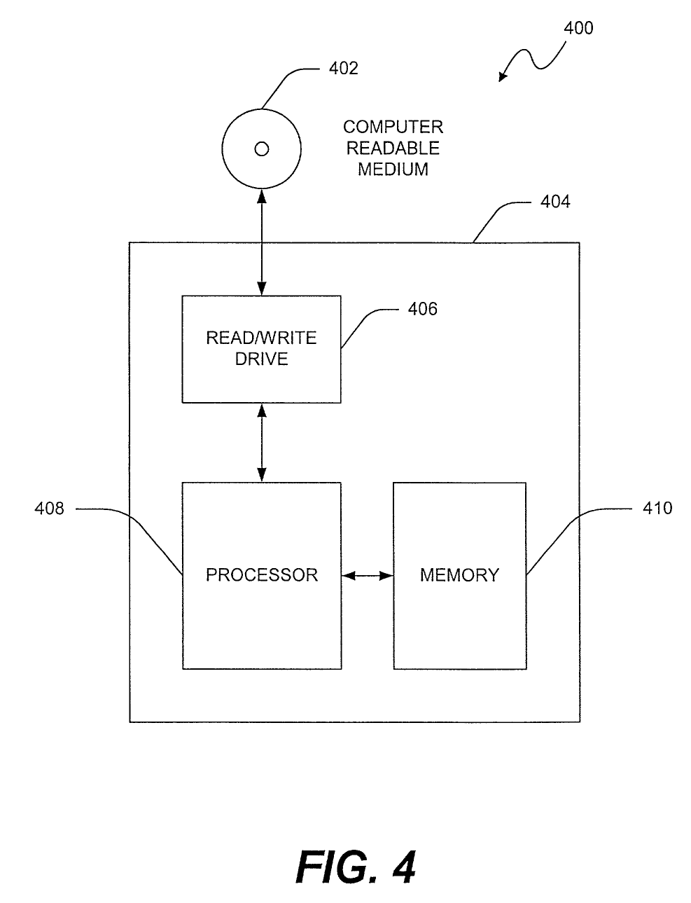

FIG. 4 is a block diagram of a processor-based system 400 which may execute the pre-boot support code residing on the computer readable medium 402. A read/write drive 406 in the computer 404 reads the code on the computer readable medium 402. The code is then executed in the processor 408.

TABLE 1

public update_aml

update_aml:

| pushad | |
|---|---|
| push ds | |
| push es | |
| pushf | |
| mov esi, cgroup:rsdt_ptr | |
| mov si, FACP_TBL_OFFSET + 40d | |
| mov edi, dword ptr [esi] | ;DSDT pointer |
| mov ecx, dword ptr [edi+4] | ;load DSDT size |
| sub ecx, 36d | ;calculate AML image size |
| add edi, 35d | ;[EDI] -> (AML image - 1) |
| mov eax, 33535F5Ch | ;\_S3 string |

next_aml_byte:

| | |
|---|---|
| inc edi | ;increment pointer |
| cmp dword ptr [edi], eax | ;check the signature |
| loopne next_aml_byte | ;next byte |
| jne update_aml_exit | ;notfound - exit |

;change the \_S3 string to \SS3 if the NEC RIMM is present in the system

| | |
|---|---|
| mov eax, 3353535ch | ;\SS3 string |
| mov dword ptr [edi], eax | |

dont_apply_nec_wa:
;update the AML checksum

| mov esi, cgroup:rsdt_ptr | |
|---|---|
| mov si, FACP_TBL_OFFSET + 40d | |
| mov edi, dword ptr [esi] | ;DSDT pointer |
| mov ecx, [edi+4] | ;get AML length |

| | |
|---|---|
| mov byte ptr [edi+9], 0 | ;zero checksum - prepare recalculation |

| | push edi | ;store &DSDT |
|---|---|---|
| | xor ax, ax | |
| checksum_loop: | | ;calculate checksum |
| | mov al, [edi] | |
| | inc edi | |
| | add ah, al | |
| | loop checksum_loop | |
| | neg ah | |
| | pop edi | ;restore &DSDT |
| | mov [edi+9], ah | ;update checksum |

update_aml_exit:

popf
pop es
pop ds
popad
ret

The processor 408 may access the computer memory 410 to store or retrieve data.

There has been disclosed herein embodiments for dynamically updating the AML code before allowing the pre-boot code to pass control of the system to the operating system. This enables a single ACPI-compliant pre-boot ROM image to handle capabilities of a plurality of boards.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, the pre-boot support code may be configured to update AML code parameters other than the suspend states. In another example, the dynamic updates are not limited to an ACPI operating system functionality, and hence, may be applied to a non-ACPI compatible operating system covering the operating system usage models across multiple environments. In other instances, well-known structures and functions were not described in elaborate detail in order to avoid obscuring the subject matter of the present invention. Accordingly, the scope and spirit of the invention should be judged in terms of the claims which follow.

What is claimed is:

1. A method for updating ACPI machine language (AML) code, comprising:
searching for a pointer to a starting address of the AML code;
providing appropriate update values for the AML code corresponding to board capabilities; and
updating the AML code with said appropriate update values.

2. The method of claim 1, wherein said pointer to a starting address of the AML code is stored in a Differentiated System Description Table.

3. The method of claim 2, further comprising:
updating size of the Differentiated System Description Table.

4. The method of claim 3, further comprising:
re-computing a checksum for the entire Differentiated System Description Table.

5. The method of claim 1, wherein said providing appropriate update values includes receiving a board stock keeping unit (SKU).

6. The method of claim 5, wherein said providing appropriate update values further includes determining the appropriate update values based on said board SKU.

7. The method of claim 1, wherein the board capabilities include suspend state parameters.

8. A method for managing interfaces and power, comprising:
searching for a pointer to a starting address of a power management machine code;
providing appropriate update values for the power management machine code corresponding to board capabilities;
updating the power management machine code with said appropriate update values; and
enabling an operating system to manage power and resources.

9. The method of claim 8, wherein said power management machine code is an AML code.

10. The method of claim 9, wherein said pointer to a starting address of the AML code is stored in a Differentiated System Description Table.

11. The method of claim 8, wherein said enabling an operating system includes reporting the board capabilities to the operating system.

12. The method of claim 8, wherein said enabling an operating system includes sending commands based on the power management machine code.

13. The method of claim 12, further comprising:
passing control to the operating system.

14. A method for reporting and handling interfaces and power, comprising:
searching for a pointer to a starting address of a power handling and reporting machine code;
providing appropriate update values for the power handling and reporting machine code corresponding to board capabilities;
updating the power handling and reporting machine code with said appropriate update values; and
enabling an operating system to manage power and resources by reporting the board capabilities to the operating system.

15. The method of claim 14, wherein said enabling an operating system further includes sending commands based on the power handling and reporting machine code.

16. The method of claim 14, wherein said power management machine code is an AML code.

17. The method of claim 16, wherein said pointer to a starting address of the AML code is stored in a Differentiated System Description Table.

18. A method for updating ACPI machine language (AML) code, comprising:
searching for a pointer to a starting address of the AML code in an ACPI table;
providing appropriate update values for the AML code corresponding to board capabilities;
updating the AML code with said appropriate update values;
updating size of the ACPI table containing the pointer to the starting address of the AML code; and
re-computing a checksum for the ACPI table.

19. The method of claim 18, wherein said pointer to a starting address of the AML code is stored in a Differentiated System Description Table.

20. The method of claim 18, wherein said ACPI table includes a Differentiated System Description Table.

21. The method of claim 18, wherein said providing appropriate update values includes receiving a board stock keeping unit.

22. A computer readable medium containing executable instructions which, when executed in a processing system, causes the system to update ACPI machine language (AML) code, comprising:
searching for a pointer to a starting address of the AML code;
providing appropriate update values for the AML code corresponding to board capabilities; and
updating the AML code with said appropriate update values.

23. The computer readable medium of claim 22, wherein said pointer to a starting address of the AML code is stored in a Differentiated System Description Table.

24. The computer readable medium of claim 23, further comprising:
updating size of the Differentiated System Description Table.

25. The computer readable medium of claim 23, further comprising:
re-computing a checksum for the entire Differentiated System Description Table.

26. An Advanced Configuration Power Interface (ACPI) system, comprising:
a pre-boot code to enable selection of ACPI capabilities according to a board parameter that defines board capabilities;
a table to store pointers to ACPI machine language code; and
an ACPI machine language code update element to update the ACPI machine language code corresponding to the board capabilities.

27. The system of claim 26, wherein said board parameter includes board's stock keeping unit.

28. The system of claim 26, wherein the table includes Differentiated System Description Table.

29. A method for managing interfaces and power, comprising:
searching for a pointer to device node structures;
providing appropriate update values for the device node structures corresponding to board capabilities;
updating the device node structures with said appropriate update values.

30. The method of claim 29, wherein said updating the device node structures includes updating the device node structures after reading General Purpose Input (GPI) values.

31. The method of claim 29, further comprising:
enabling an operating system to manage power and resources.
